(19) United States
(12) Patent Application Publication
(10) Pub. No.: US 2025/0335653 A1
(43) Pub. Date: Oct. 30, 2025

(54) BIORID ATD POSITIONING FOR SEAT SYSTEM EVALUATION IN VIRTUAL SIMULATION IN CAE ENVIRONMENT

(71) Applicant: GM GLOBAL TECHNOLOGY OPERATIONS LLC, Detroit, MI (US)

(72) Inventors: Gajanan HUNAGUND, Karnataka (IN); Rigswattwa Basu, West Bengal (IN)

(21) Appl. No.: 18/651,209

(22) Filed: Apr. 30, 2024

(51) Int. Cl. G06F 30/20; G06F 30/15; G06F 119/14

(52) U.S. Cl. CPC G06F 30/20; G06F 30/15; G06F 2119/14

(57) ABSTRACT

A seat testing system is disclosed and includes: at least one of an interface and a control module configured to receive inputs; a dummy positioning module configured i) to position an anthropomorphic test device (ATD) in a seat system to be tested in a virtual computer aided engineering environment, ii) to access target parameters including the inputs, and iii) based on the target parameters, to determine parameters indicative of the positioning of the ATD in the seat system; and a simulation evaluation module configured i) based on the parameters, to run the ATD and the seat system through a simulation of a collision in the virtual computer aided engineering environment, and ii) based on results of the simulation, to generate a rating of the seat system.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to simulation tools, and more particularly to virtual evaluation tools for seat systems of vehicles.

Automotive vehicles include various seating systems with various types of seats. The seats include first row, send row and third row bucket and bench style seats. The seats can be 50/50 split bench seats or 40/20/40 bench seats. Automotive manufactures perform various types of testing on seat systems to make sure the seat systems satisfy structural, safety, durability, noise and vibration, and other requirements. This can include performing HYGE sled testing and in-vehicle testing of the seat systems. The tests include use of an anthropomorphic test devices (referred to as a crash test dummies or simply dummies). As an example, a dummy can be placed in a seat to be tested on a HYGE sled and the HYGE sled is accelerated according to a predetermined pulse pattern for a corresponding type of collision and particular vehicle. Sensors in the dummy and/or on the seat collect data during the test. The data is then evaluated to determine performance of the seat system and the seat system is rated based on the collected data.

### SUMMARY

A seat testing system is disclosed and includes: at least one of an interface and a control module configured to receive inputs; a dummy positioning module configured i) to position an anthropomorphic test device (ATD) in a seat system to be tested in a virtual computer aided engineering environment, ii) to access target parameters including the inputs, and iii) based on the target parameters, to determine parameters indicative of the positioning of the ATD in the seat system; and a simulation evaluation module configured i) based on the parameters, to run the ATD and the seat system through a simulation of a collision in the virtual computer aided engineering environment, and ii) based on results of the simulation, to generate a rating of the seat system.

In other features, the inputs include at least one of user inputs, design of experiment inputs, and consumer metrics for a physical setup.

In other features, the ATD is a biofidelic rear impact dummy.

In other features, the dummy positioning module is configured to automatically position the ATD in the seat system in the virtual computer aided engineering environment based on the target parameters, which include consumer metric physical test setup parameters.

In other features, the dummy positioning module is configured to compare one or more of the parameters to the target parameters, and based on the comparison, adjust one or more of the parameters to generate updated parameters including the adjusted one or more of the parameters and the other ones of the parameters. The simulation evaluation module is configured, based on the updated parameters, to run the ATD and the seat system through the simulation of the collision in the virtual computer aided engineering environment.

In other features, the target parameters include a required H-point coordinates, a required backset, and an initial pelvic angle. The parameters include an updated pelvic angle, a head rotation angle, and a head translation position.

In other features, the dummy positioning module is configured to: position a torso of the ATD and set a backset of the ATD by changing a pelvic angle of the ATD until the backset matches a target backset; and calculate a backset of the ATD by determining a distance between a backset node on a back of a head of the ATD and a front surface of a skin of a head rest of the seat system. The parameters include the calculated backset.

In other features, the dummy positioning module is configured to: determine if a head of the ATD is level based on positions of reference nodes in the head; in response to determining that the head is not level, change a current pelvic angle of the ATD and determine a pelvic angle at which the head is able to be leveled; and subsequent to leveling the head, adjust a backset of the ATD to achieve a target backset by translating the head.

In other features, the dummy positioning module is configured to: place hands of the ATD beside legs of the ATD and near a surface of the seat system; calculate an upper arm assembly angle of an upper arm assembly, where the upper arm assembly is in contact with a seat back of the seat system; and calculate a lower arm assembly angle to bring the hands of the ATD down near a surface of the seat system. The parameters include the upper arm assembly angle and the lower arm assembly angle.

In other features, the dummy positioning module is configured to after adjusting a H-point of the ATD to standard H-point coordinates: position pelvis and head according to a backset requirement; and position hands and legs of the ATD to maintain a standard position of the ATD on the seat system. The parameters include a resultant pelvic angle, a resultant head rotation angle and position, and locations of the hands and the legs of the ATD.

In other features, the dummy positioning module is configured to: recording the resultant pelvic angle, the resultant head rotation angle and position, and the locations of the hands and legs as a first positioning script; and iteratively adjust H-point coordinates, backset, and pelvic angle of the ATD to be within tolerance ranges of the standard H-point coordinates, required backset, and a standard pelvic angle, and for each iteration generate a respective positioning script to provide positioning scripts.

In other features, the simulation evaluation module is configured to run a simulation for each of the first positioning script and the positioning scripts.

In other features, the dummy positioning module is configured to: receive required backset setting; determine a current pelvic angle of the ATD while on the seat system; determine a backset of a head of the ATD relative to a head rest of the seat system; determine a rate of change in the backset per a 0.1° change in the current pelvic angle; and determine a required pelvic angle of the ATD based on the current pelvic angle, a current backset, a require backset, and a rate of change of the backset. The parameters include the required pelvic angle.

In other features, a method for testing a seat system is disclosed. The method includes: receiving inputs; positioning an ATD in the seat system to be tested in a virtual computer aided engineering environment; accessing target parameters including the inputs, and, based on the target parameters, determining parameters indicative of the positioning of the ATD in the seat system; based on the parameters, running the ATD and the seat system through a simulation of a collision in the virtual computer aided engineering environment; and based on results of the simulation, generating a rating of the seat system.

In other features, the inputs include at least one of user inputs, design of experiment inputs, and consumer metrics for a physical setup. The ATD is a biofidelic rear impact dummy. The dummy positioning module is configured to automatically position the ATD in the seat system in the virtual computer aided engineering environment based on the target parameters, which include consumer metric physical test setup parameters.

In other features, the method further includes: comparing one or more of the parameters to the target parameters; based on the comparison, adjusting one or more of the parameters to generate updated parameters including the adjust one or more of the parameters and the other ones of the parameters; and based on the updated parameters, running the ATD and the seat system through the simulation of the collision in the virtual computer aided engineering environment.

In other features, the method further includes: positioning a torso of the ATD and set a backset of the ATD by changing a pelvic angle of the ATD until the backset matches a target backset; and calculating a backset of the ATD by determining a distance between a backset node on a back of a head of the ATD and a front surface of a skin of a head rest of the seat system. The parameters include the calculated backset.

In other features, the method further includes: determining if a head of the ATD is level based on positions of reference nodes in the head; in response to determining that the head is not level, changing a current pelvic angle of the ATD and determine a pelvic angle at which the head is able to be leveled; and subsequent to leveling the head, adjusting a backset of the ATD to achieve a target backset by translating the head.

In other features, the method further includes: placing hands of the ATD beside legs of the ATD and near a surface of the seat system; calculating an upper arm assembly angle of an upper arm assembly, where the upper arm assembly is in contact with a seat back of the seat system; and calculating a lower arm assembly angle to bring the hands of the ATD down near a surface of the seat system. The parameters include the upper arm assembly angle and the lower arm assembly angle.

In other features, the method further includes after adjusting a H-point of the ATD to standard H-point coordinates: positioning pelvis and head according to a backset requirement; positioning hands and legs of the ATD to maintain a standard position of the ATD on the seat system, where the parameters include a resultant pelvic angle, a resultant head rotation angle and position, and locations of the hands and legs of the ATD; recording the resultant pelvic angle, the resultant head rotation angle and position, and the locations of the hands and legs as a first positioning script; and iteratively adjusting H-point coordinates, backset, and pelvic angle of the ATD to be within tolerance ranges of the standard H-point coordinates, required backset, and a standard pelvic angle, and for each iteration generate a respective positioning script to provide positioning scripts.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a portion of a seat collision testing system including a dummy positioning module and a simulation evaluation module in accordance with the present disclosure;

FIG. 2 is a functional block diagram of a seat evaluating device including the seat collision testing system in accordance with the present disclosure;

FIG. 3 is a functional block diagram of the dummy positioning module of FIG. 1;

FIG. 4 is a side perspective view of a dummy head assembly and a head rest illustrating a backset and a backset node;

FIG. 5 is a side perspective view of a dummy pelvic assembly illustrating an H-point angle;

FIG. 6 illustrates a method of determining a backset of a dummy in a seat system in accordance with the present disclosure;

FIG. 7 illustrates a method of determining a rate of change of a backset per degree of change in pelvic angle in accordance with the present disclosure;

FIG. 8 is a side perspective cutaway view of a dummy head illustrating head alignment nodes and a head rotation center node;

FIG. 9 illustrates a method of positioning a head of a dummy in accordance with the present disclosure;

FIG. 10 is a side perspective view a left arm and hand of a dummy illustrating an upper arm assembly, a lower arm assembly, a left-hand elbow node and a left-hand finger node;

FIG. 11 illustrates a method of positioning a hand of a dummy in accordance with the present disclosure;

FIG. 12 is a side perspective view of a left leg and foot of a dummy illustrating an upper leg assembly, a lower leg assembly, a foot assembly and a heel node.

FIG. 13 illustrates a method of determining H-point coordinates and a change in backset in accordance with the present disclosure;

FIG. 14 illustrates a method of determining an initial backset, an initial left-hand elbow node position, an initial left-hand finger node position and an initial heel node position in accordance with the present disclosure;

FIG. 15 illustrates a method of determining variation parameter sets of variations in dummy seated positions in accordance with the present disclosure; and

FIG. 16 is a front view of a dummy illustrating a gap between knees of the dummy.

In the drawings, reference numbers may be reused to identify similar and/or identical elements.

### DETAILED DESCRIPTION

The preparation, scheduling, and actual physical testing of a seat (or seat system) can take weeks. In addition, the manual positioning of a dummy in a seat system is time consuming and can vary between test engineers and/or technicians placing the dummy.

The examples set forth herein include a seat collision testing system that positions a dummy in a seat system to be tested in a virtual computer aided engineering (CAE) environment. The seat collision testing system includes a dummy positioning module that automatically determines positioning scripts including sets of dummy positioning parameters. The dummy positioning parameters are provided to a simulation evaluation module (or solver) that runs impact simulations for each positioning script to quickly provide ratings for each positioning script for seat performance evaluation. The generation of the positioning scripts and corresponding simulations are able to be quickly performed in a virtual environment. This allows for a seat system to be quickly and iteratively evaluated in a virtual environment, thereby minimizing design and testing time, the amount of physical testing needed, and associated costs.

The seat collision testing system is able to, for example, position a biofidelic rear impact dummy (BioRID) automatically in a seat system in a virtual CAE environment per consumer metrics, such as new car assessment program (NCAP) metrics and insurance institute for highway safety (IIHS) metrics associated with physical test setups. The NCAP metrics include Chinese NCAP (CNCAP), European NCAP (ENCAP), Korean NCAP (KNCAP), and Latin NCAP (LNCAP) metrics. The positioning of the BioRID in the virtual environment mimics the positioning in the physical testing environment.

The seat collision testing system is able to perform variation analysis by automating the positioning of a dummy. Variation analysis refers to the testing of a standard (or baseline) set of positioning parameters and testing each of multiple other sets of parameters that are different than the standard set of positioning parameters. Each parameter in the standard set of positioning parameters has a corresponding tolerance range, which may correspond to variations in that parameter if testing were to occur in the physical environment. For example, a test engineer may position the head of the dummy in a first position for a first test of a first seat system. The same test engineer or another test engineer may position the head of the dummy in a second position of a second seat system for a second test, which may be slightly different than the first position. The second seat system is the same type and style seat system and has the same manufacturer part number as the first seat system. The other sets of parameters (referred to as variation parameter sets) are thus parameters that are different than the standard set of positioning parameters but within corresponding tolerance ranges of the standard set of positioning parameters.

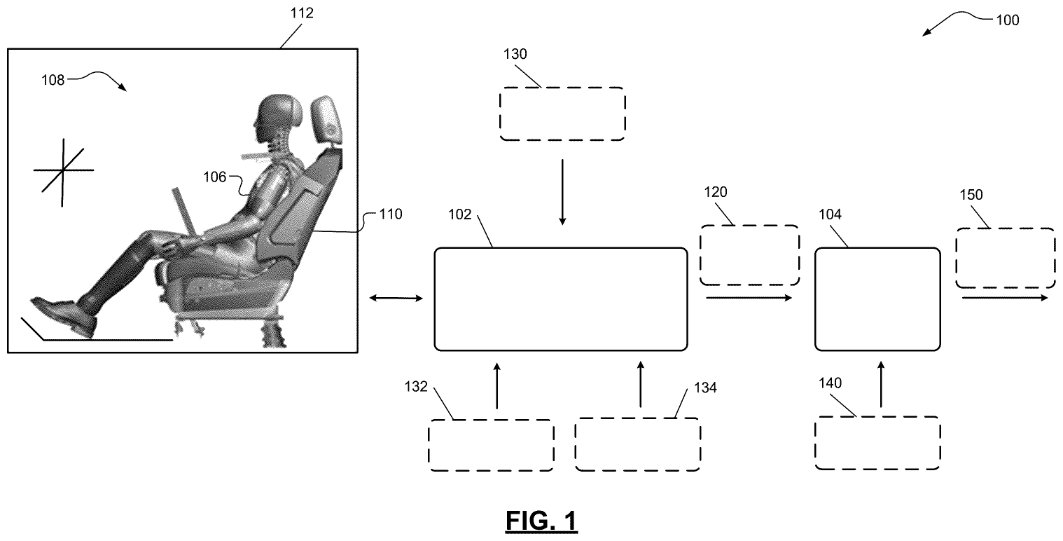

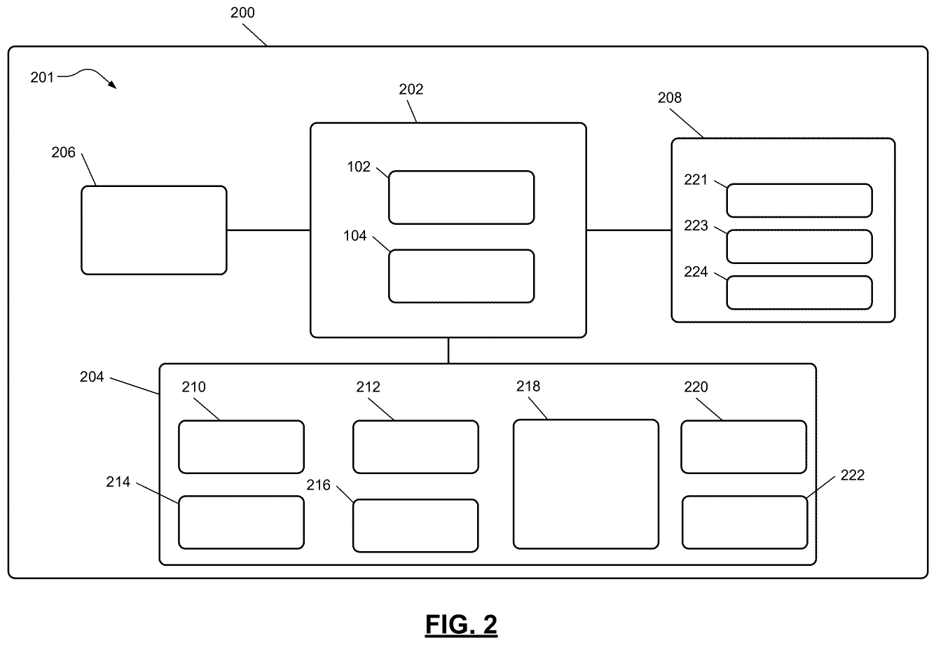

FIG. 1 shows a portion 100 of a seat collision testing system (shown further in FIG. 2) including a dummy positioning module 102 and a simulation evaluation module 104. The dummy positioning module 102 positions a dummy (e.g., a BioRID 106 such as the BioRID II) in a virtual CAE environment 108 in a seat system (e.g., a seat system 110). The virtual CAE environment 108 may be shown via a display 112. The dummy positioning module 102 is configured to determine standard (or baseline) positioning of the dummy 106 in the seat system 110 and other seat positioning variations and corresponding sets of parameters, referred to as sets of dummy positioning parameters 120.

The dummy positioning parameters 120 for each position of the dummy 106 in the seat system 110 includes H-point coordinates, backset, pelvis angle, head position coordinates (e.g., coordinates of head alignment nodes and center node), arm position coordinates (e.g., elbow node coordinates), hand position coordinates (e.g., finger node coordinates), leg position coordinates, and foot position coordinates (e.g., heel node coordinates). The nodes refer to certain reference points on the dummy, as further described below.

The dummy positioning module 102 is configured to determine the stated dummy positioning parameters 120 based on requirement information 130, dummy specific information 132, and first seat specific information.

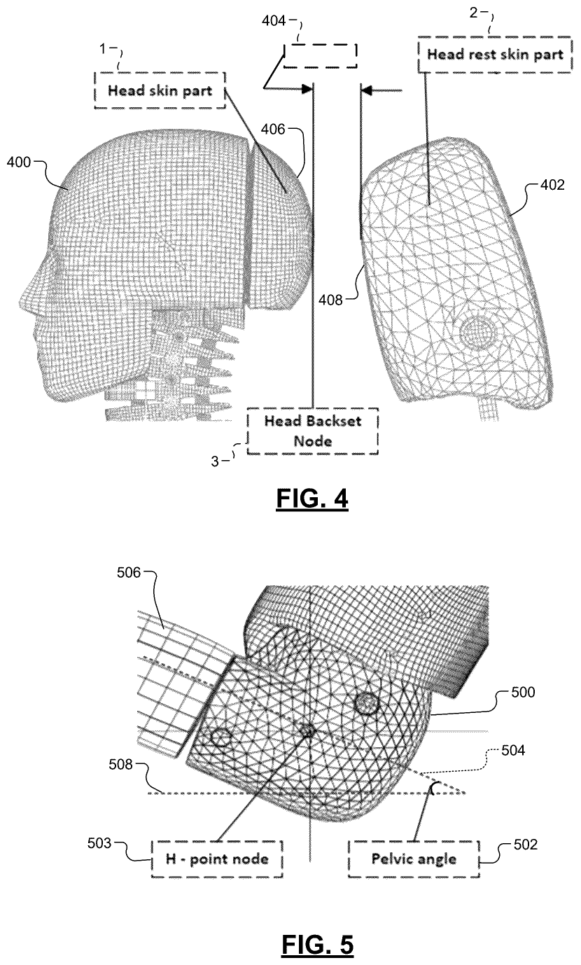

The requirement information 130 may include NCAP requirements such as requirements for H-point X and Z coordinates, backset, and initial pelvic angle. FIG. 1 shows X, Y and Z axes. FIG. 4 illustrates an example backset, which refers to a minimum distance between a back of a dummy head and a front surface of a head rest (or head restraint). The dummy specific information 132 may include dummy specific geometry, a model of the dummy, weight, center of gravity (CG) of dummy, CG of head, CG of torso, height, geometry of each component of dummy, assembly information, materials of components, performance attributes, etc. The seat specific information 134 may include: a model of the seat system, seat specific geometry including dimensions of seat cushion, seat back, head rest, etc.; seat weight; dimensions and weights of seat components, spring tensions and layouts, types of materials on seat cushion, seat back and head rest; seat back attachment and pivot point locations; head rest attachment and pivot point locations; etc.

The simulation evaluation module 104 receives the dummy positioning parameters 120 and second seat specific information 140. The second seat specific information may be the same or different than the first seat specific information 134. Based on the dummy positioning parameters 120 and the second seat specific information 140, the simulation evaluation module 104 runs multiple virtual simulations, performs finite element analysis on data collected from the simulations, and, for each simulation, generates a seat system rating. The seat system ratings are designated 150. The seat system ratings 150 are used to evaluate performance of the seat system 110. The seat system ratings 150 may include stress and strain values, seat back rotation angles and/or deflection distances, indications of whether a neck injury is likely, confidence values, etc. The seat system ratings 150 may include confidence levels indicative of whether a seat system is likely to pass certain requirements during a physical impact test. An overall or average seat system rating may be generated based on the seat system ratings generated as a result of the simulations.

Each simulation of the dummy and seat system during a collision event may be displayed on the display 112 including motion of the dummy and seat system when the seat system is accelerated. The simulations may be rear impact simulations, which test the seat system with a BioRID in the seat system. This may include seat pan performance, seat back performance, head rest performance, and overall structural performance. A seat belt (not shown in FIG. 1) may be applied and used to limit movement of the dummy. The seat belt may include a lap belt and a shoulder belt.

FIG. 2 shows a seat evaluating device 200 including the seat collision testing system 201. The seat collision testing system 201 includes a control module 202, a memory 204, a transceiver 206 and user interface devices 208. The control module 202 may implement the dummy positioning module (or tool) 102 and the simulation evaluation module 104. Although the simulation evaluation module 104 is shown as being implemented by the control module 202, the simulation evaluation module 104 may be implemented by another control module and/or device separate from and communication with the seat evaluating device 200.

The memory 204 may store dummy specific information 210, requirement information 212, seat specific information 214, seat system ratings 216, dummy positioning parameter sets 218, seat system models 220, and virtual software environment application 222. The dummy specific information 210 includes information specific to one or more dummies, such as the dummy specific information 132 of FIG. 1. The requirement information 212 may include requirements and tolerances for each dummy-seat system pairing. The requirements information may include the requirement information 130 of FIG. 1. The seat specific information 214 includes information specific to one or more seat systems, such as the seat specific information 134, 140 of FIG. 1. The seat system ratings 216 include ratings generated by the simulation evaluation module 104 for each of the run simulations. The dummy positioning parameter sets 218 are generated by the dummy positioning module 102 as described herein and may be stored as respective positioning scripts in respective positioning files in the memory 204. The dummy positioning parameter sets 218 include, for each dummy-seat system pair, a standard parameter set and variation parameter sets. The dummy positioning parameter sets 218 may be stored and displayed in tabular form. The seat system models 220
may include the seat specific information 214 and/or other information specific to different seat systems including models of each of the seat systems. The virtual software environment application 222 provides a virtual environment for displaying and testing dummies and seat systems. The virtual software environment application 222 may have user interface features.

The transceiver 206 may receive, for example, the requirement information 212 from a network device separate from the seat evaluating device 200. The transceiver 206 may also report simulation results to the network device and/or other network device (e.g., a back office, a cloud-based network device, etc.) remotely located away from the seat evaluating device 200. A network device separate from the seat evaluating device 200 may provide requirement information based on the simulation results. The dummy positioning module 102 may generate dummy positioning parameter sets based on the received requirement information and the simulation evaluation module 104 may then run additional simulations to obtain updated simulation results, which may then be reported back to the network device.

The user interface devices 208 may include a display 221 (e.g., the display 112 of FIG. 1), a keyboard 223, and a mouse 224. A user may enter known seat system and/or dummy parameters and/or requirements via the interface devices 208. A user may also adjust dummy positioning requirements and/or seat system design parameters via the interface devices 208, run simulations, and adjust the seat system design parameters based on results of the simulations.

In an embodiment, the dummy positioning module (or tool) 102 is launched in a virtual software environment application 222 implemented by the control module 202. A seat system model including seat specific information that is loaded for a seat system to be tested. The seat system model may be loaded into the virtual software environment application 222 and include a minimum number of inputs. Seat positioning and occupant (or dummy) positioning is performed by the dummy positioning module 102 based on consumer metrics for physical test setups but in a virtual CAE environment. In an embodiment, seat system models and corresponding dummy positioning parameter sets are provided and collisions are simulated in the virtual CAE environment via a high-performance computing (HPC) module, which is the simulation evaluation module 104. Multiple dummy positioning parameter sets are generated for variations in dummy seat positioning corresponding to variations that can occur in the physical environment.

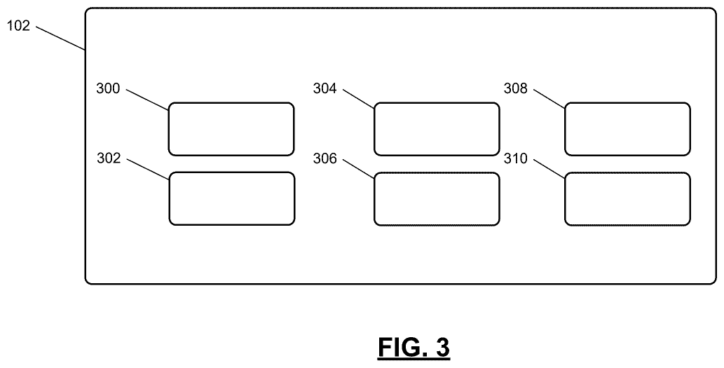

FIG. 3 shows the dummy positioning module 102, which includes a backset determining module 300, a rate of change module 302, a head positioning module 304, arm and hand positioning module 306, a leg and foot positioning module 308, and a variation module 310. The backset determining module 300 determines backrest values. The rate of change module 302 determines a rate of change of the backset. The head positioning module 304 positions a head of a dummy and determines head angle and head coordinates. The arm and hand positioning module 306 positions an arm and hand of a dummy and determines arm and hand coordinates. The leg and foot positioning module 308 positions a leg and foot of a dummy and determines arm and hand coordinates. The variation module 310 determines variation parameter sets.

FIG. 4 shows a dummy head assembly (or head) 400 and a head rest 402 illustrating a backset 404. The backset 404 refers to a minimum distance between a back (or back surface) 406 of a head skin part (or head skin) 1 of the head 400 and a front surface 408 of a head rest skin part (or head rest skin) 2 of the head rest 402. A backset node 3 refers to a point on the back 406 of the head 400 that is closest to the surface 408 of the head rest 402.

FIG. 5 shows a dummy pelvic assembly (or pelvis) 500 illustrating an H-point (or pelvic) angle 502 associated with a H-point node 503. The H-point angle refers to an angle between a centerline 504 of the upper leg (or thigh) 506 of the dummy and a horizontal reference line 508.

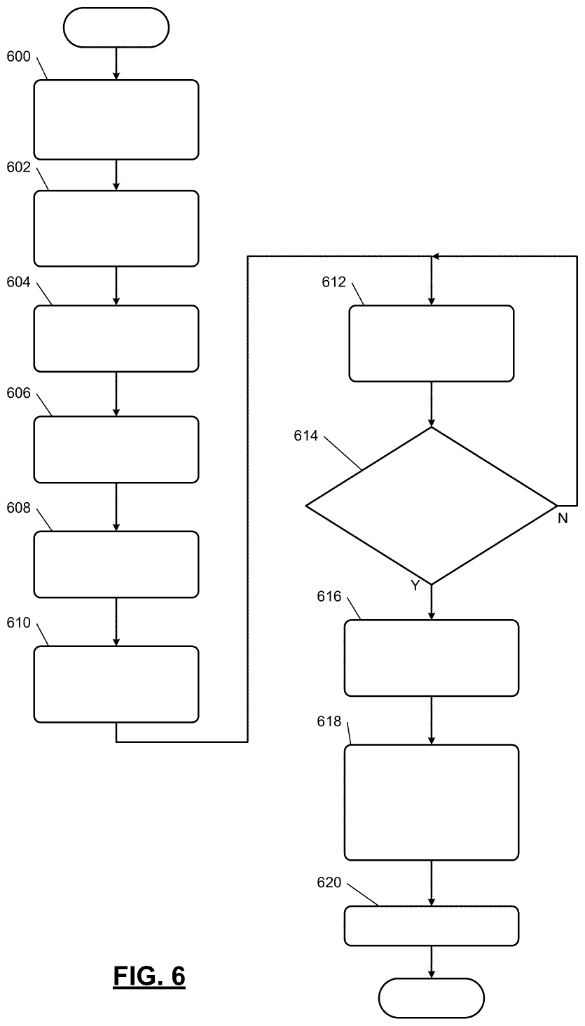

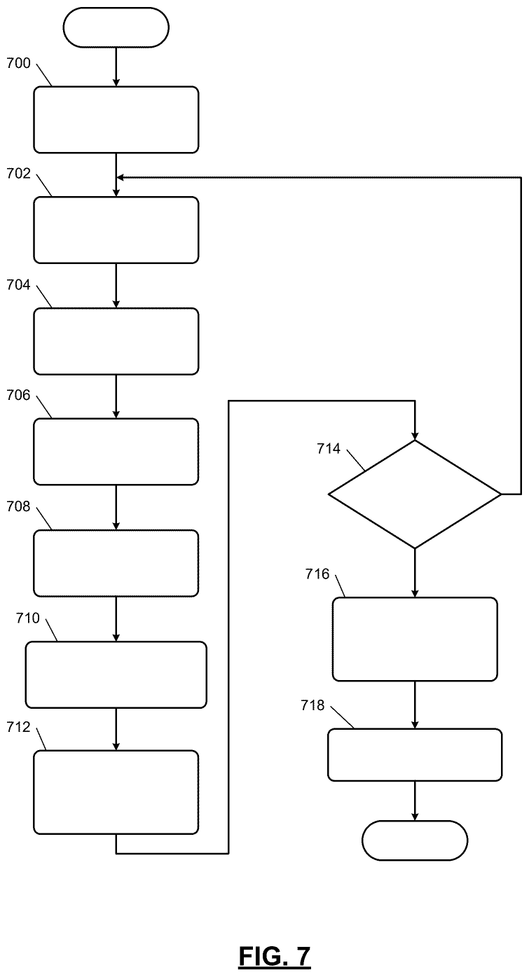

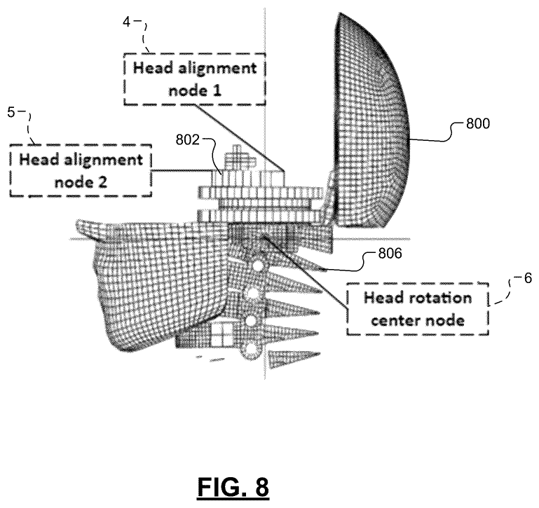

The dummy positioning module 102 of FIGS. 1-3 may determine a required pelvic angle of a dummy using, for example, equation 1. The current backset may be determined by implementing the method of FIG. 6. The rate of change of backset may be determined by implementing the method of FIG. 7.

$$Requred Pelvic Angle = Current Pelvic Angle + \frac{Current Backset - Requred Backset}{Rate of Change of Backset} * 0.1 \qquad ( 1 )$$

The dummy positioning module 102 may store the required pelvic angle in the memory 204 as a parameter of one of the positioning scripts.

The following methods of FIGS. 6, 7, 9, 11, and 13-15 include operations that are implemented in the virtual CAE environment and are described with respect to FIGS. 1-5, 8, 10, 12 and 16.

FIG. 6 shows a method of determining a current backset of a dummy in a seat system (or seat) to be tested. The following operations may be iteratively performed. At 600, the backset determining module 300 of FIG. 3 receives inputs from a user including H-point coordinates of a dummy (e.g., BioRID dummy) when seated on the seat.

At 602, the backset determining module 300 translates (or moves) the dummy on the seat to match the H-point coordinates of the dummy with the received H-point coordinates.

At 604, the backset determining module 300 identifies the head skin of the dummy head. At 606, the backset determining module 300 identifies the head rest skin of the seat.

At 608, the backset determining module 300 records current X coordinate of head backset node (e.g., node 3 of FIG. 4). At 610, the backset determining module 300 defines a contact between the head skin and the head rest skin. This may include defining an area of the head and an area of the head rest that will be in contact with each other during a collision event. At 612, the backset determining module 300 translates (or moves) the dummy head including the head skin along the X-axis towards the head rest skin.

At 614, the backset determining module 300 determines whether there is reference node penetration detected. For example, the backset determining module 300 may determine whether there is contact between the head skin and the head rest skin during movement of the dummy head. If not, operation 612 is continued, otherwise operation 616 may be performed.

At 616, the backset determining module 300 records a final X coordinate position of the backset node. At 618, the backset determining module 300 determines a difference in recorded coordinate values of the head skin and head rest skin to determine a current backset.

At 620, the backset determining module 300 stores the current backset in the memory 204. The current backset may be stored as part of a positioning script of a positioning file.

FIG. 7 shows a method of determining a rate of change of a backset per degree of change in pelvic angle. The following operations may be iteratively performed.

At 700, the rate of change module 302 of FIG. 3 receives an initial pelvic angle. This may be provided by a user via a user interface. As an example, the initial pelvic angle may be 24.7°. At 702, the rate of change module 302 records a current X coordinate of the dummy head backset node.

At 704, the rate of change module 302 rotates pelvis assembly by 0.1 degrees clockwise. At 706, the rate of change module 302 rotates the dummy head by 0.1 degrees counterclockwise.

At 708, the rate of change module 302 records a final X coordinate of head backset node. At 710, the rate of change module 302 determines the difference in the recorded coordinate values. At 712, the rate of change module 302 determines the change in backset for 0.1 degrees change in pelvic angle.

At 714, the rate of change module 302 determines whether the current pelvic angle is equal to a target (or required) pelvic angle. If not, operation 702 is performed, otherwise operation 716 is performed.

At 716, the rate of change module 302 calculates a rate of change of backset per degree change in pelvic angle. As an example, the rate of change may be 10.5 millimeters per degree change in the pelvic angle.

At 718, the rate of change module 302 stores current rate of change of backset. The current rate of change may be stored as part of a positioning script of a positioning file.

FIG. 8 shows a dummy head 800 that includes a first head alignment node 4, a second head alignment node 5, and a head rotation center node 6. The nodes 4, 5 are on opposite corners of a first block 802 inside the portion of the dummy head representing a cranium. The head rotation center node 6 refers to a pivot point of the head relative to a spine 806 of the dummy.

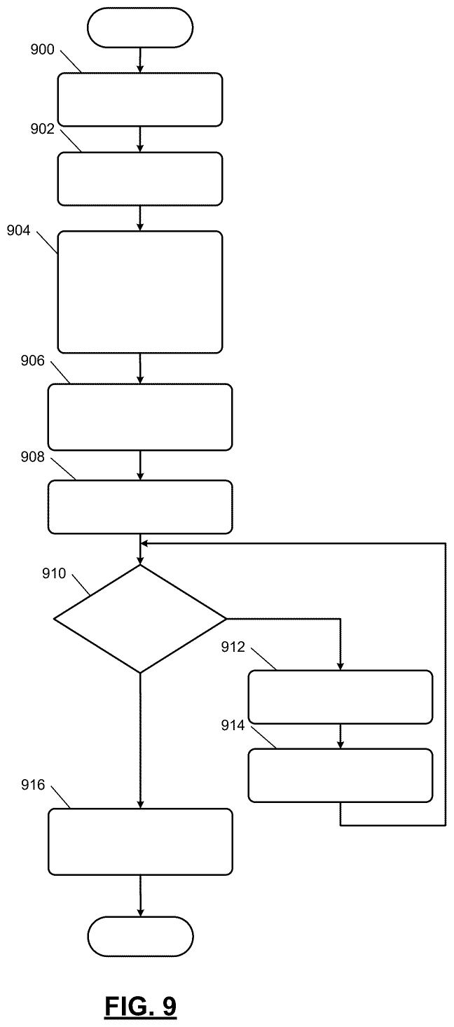

FIG. 9 shows a method of positioning a head of a dummy. The following operations may be iteratively performed.

At 900, the head positioning module 304 of FIG. 3 receives a target (or required) backset. This may be provided by a user via a user interface. At 902, the head positioning module 304 calculates a target pelvic angle.

At 904, the head positioning module 304, based on positions of the first head alignment node 4 and the second head alignment node 5 of FIG. 8, calculates inclination of the dummy head.

At 906, the head positioning module 304 rotates head with respect to position of the head rotation center node 6. The head is able to pivot about the head rotation center node 6 (or reference lines extending through the node 6 and parallel to the Y-axis).

At 908, the head positioning module 304 calculates current backset based on current positions of the nodes 4, 5 and head angle. At 910, the head positioning module 304 determines whether the target (or required) backset has been achieved (i.e., the current backset matches the target backset). If no, operation 912 may be performed, otherwise 916 may be performed.

At 912, the head positioning module 304 calculates a head translation distance. At 914, the head positioning module 304 translates the dummy head along the X-axis.

At 916, the head positioning module 304 stores head rotation angle and head translation position in the memory 204. The head rotation angle and head translation position may be stored as part of a positioning script of a positioning file.

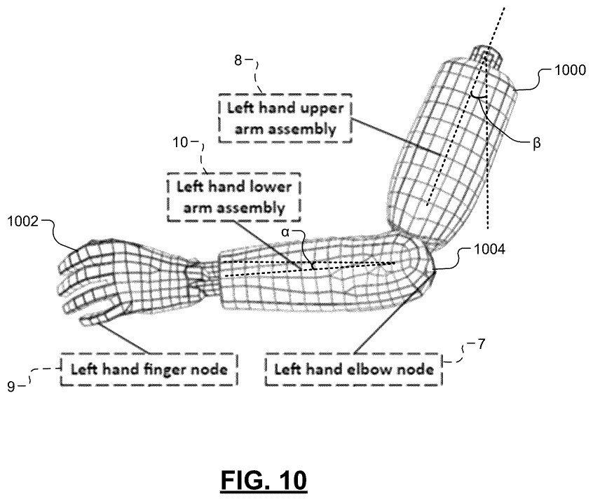

FIG. 10 shows a left arm 1000 and a left hand 1002 of a dummy illustrating an upper arm assembly 8, a lower arm assembly 10, a left-hand elbow node 7 and a left-hand finger node 9. The left-hand elbow node 7 is a point at an end 1004 of the lower arm assembly 10. The end of the lower arm assembly 10 represents an elbow. The left-hand finger node 9 refers to a point on one of the fingers of the dummy, such as a point on a little finger (or pinkie) of the dummy.

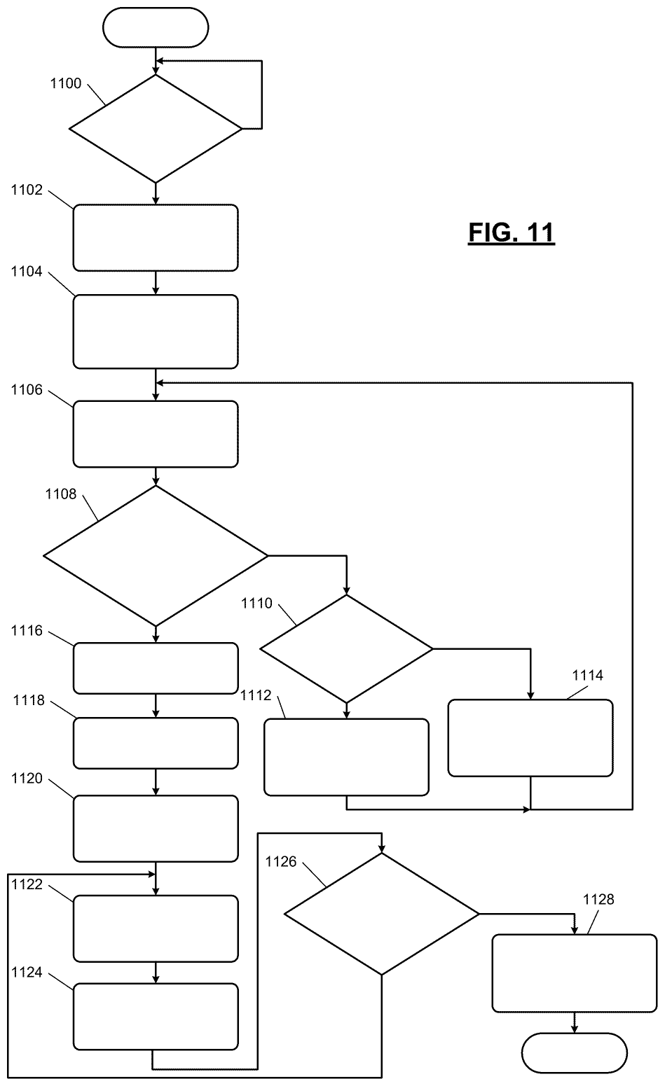

FIG. 11 shows a method of positioning a hand of a dummy. The following operations may be iteratively performed.

At 1100, the arm and hand positioning module 306 of FIG. 3 determines whether the current pelvic angle of the dummy is set for a target backset. If yes, operation 1102 may be performed. At 1102, the arm and hand positioning module 306 determines an X-coordinate of the left-hand elbow node 7.

At 1104, the arm and hand positioning module 306 determines a location of a node (or point) on a seat being tested that is nearest to the left-hand elbow node 7. During operations 1102, 1104, an intersection point may be determined based on locations of the nearest node and the left-hand elbow node 7.

At 1106, the arm and hand positioning module 306 rotates the left-hand upper arm assembly 8 of the dummy. At 1108, the arm and hand positioning module 306 determines whether the upper arm assembly 8 is touching seat back with current backset. If no, operation 1110 may be performed, otherwise operation 1116 may be performed.

At 1110, the arm and hand positioning module 306 determines whether the upper arm assembly is intersecting (contacting) with the seat back. If yes, operation 1112 may be performed, otherwise operation 1114 may be performed.

At 1112, the arm and hand positioning module 306 moves the upper arm assembly 8 clockwise 0.5°. At 1114, the arm and hand positioning module 306 moves the upper arm assembly 8 counterclockwise −0.5°. Operation 1106 may be performed subsequent to operations 1112 and 1114.

At 1116, the arm and hand positioning module 306 rotates the left-hand upper arm assembly 8. At 1118, the arm and hand positioning module 306 fixes the position of the upper arm assembly 8.

At 1120, the arm and hand positioning module 306 rotates the left lower arm assembly 10 upward above the legs of the dummy. At 1122, the arm and hand positioning module 306 rotates the left lower arm assembly 10 downwards 1°.

At 1124, the arm and hand positioning module 306 determines position of the left-hand finger node 9. At 1126, the arm and hand positioning module 306 determines whether the left lower arm assembly 10 is touching the seat cushion.

At 1128, the arm and hand positioning module 306 stores positions of the left-hand elbow node 7 and the left-hand finger node 9 in the memory 204. The positions may be stored as part of a positioning script of a positioning file.

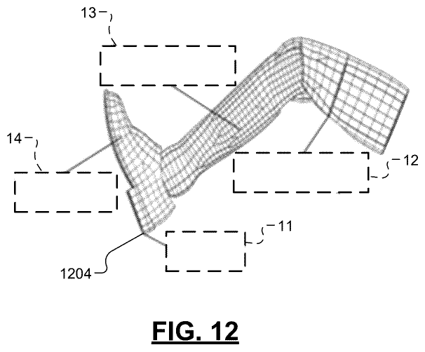

FIG. 12 shows a left leg 1200 and foot 1202 of a dummy illustrating a heel node 11, an upper leg assembly 12, a lower leg assembly 13, and a foot assembly 14. The heel node 11 refers to a point at a bottom edge 1204 of a heel of the foot assembly 14.

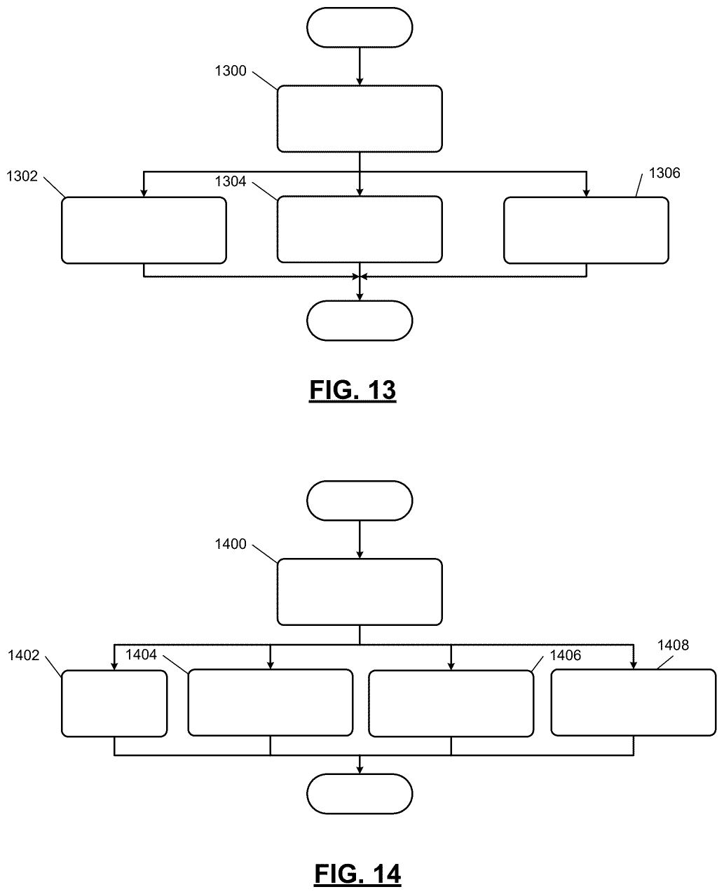

FIG. 13 shows a method of determining H-point coordinates and a change in backset. The following operations may be iteratively performed.

At 1300, the dummy positioning module 102 of FIG. 3 receives a known design of experiments (DOE) data. The DOE data may include requirements (or targets) for dummy H-point coordinates, backset, and initial pelvic angle.

At 1302, the dummy positioning module 102 changes the X-coordinate of a H-point of a dummy (e.g., dummy 106 of FIG. 1) in a seat system being tested. The X-coordinate is changed based on and to match the X-coordinate for the H-point as indicated by the DOE data.

At 1304, the dummy positioning module 102 changes a Z-coordinate of the H-point of the dummy based on and to match the Z-coordinate for the H-point as indicated by the DOE data. At 1306, the dummy positioning module 102 changes the backset based on and to match the backset as indicated by the DOE data.

FIG. 14 shows a method of determining an initial backset, an initial left-hand elbow node position, an initial left-hand finger node position and an initial heel node position. The following operations may be iteratively performed.

At 1400, the dummy positioning module 102 receives a standard dummy positioning model including a standard set of positioning parameters, such as standard H-point coordinates, a standard backset, and a standard initial pelvic angle.

At 1402, the dummy positioning module 102 fixes an initial backset of a dummy (e.g., dummy 106 of FIG. 1) in a seat system being tested. At 1404, the dummy positioning module 102 determines an initial position of a left-hand elbow node (e.g., node 7) based on the received standard positioning model.

At 1406, the dummy positioning module 102 determines an initial position of a left-hand finger node (e.g., node 9) based on the received standard positioning model. At 1408, the dummy positioning module 102 determines an initial position of a heel (e.g., node 11) based on the received standard positioning model.

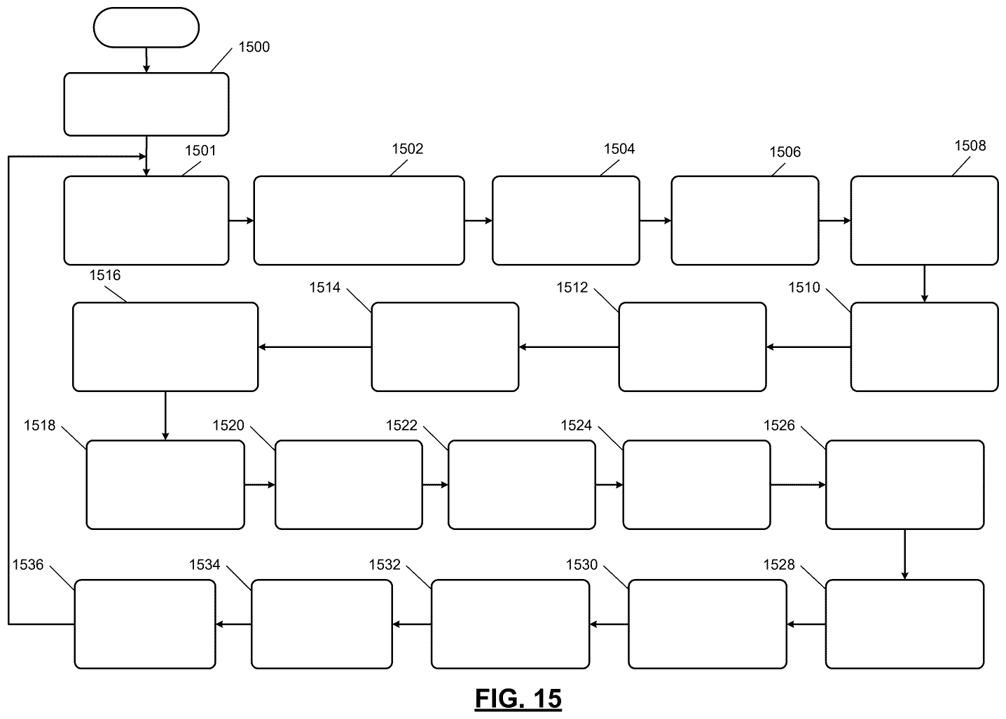

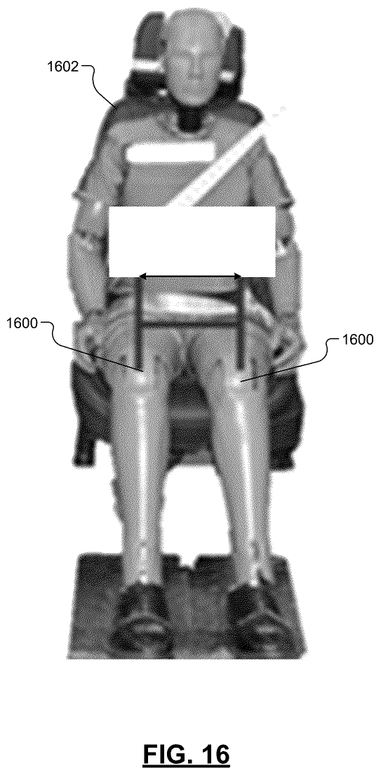

FIG. 15 shows a method of generating variation dummy positioning models including determining variation parameter sets of variations in dummy seated positions. The following operations may be iteratively performed.

At 1500, the variation module 310 load initial data and/or model(s) of dummy and seat system being tested. The loaded model(s) may include a standard dummy position model. The model(s) may include standard requirements and tolerances. At 1501, the variation module 310 of FIG. 3 determines a required backset based on a change in backset and an initial backset. At 1502, the variation module 310 determines final H-point coordinates based on H-point coordinates of dummy on seat (e.g., H-point coordinates of dummy after performing operation 602 of FIG. 6) and changes in X and Z coordinates of H-point.

At 1504, the variation module 310 translates dummy to new H-point coordinates. At 1506, the variation module 310 calculates a current backset with dummy having the new H-point coordinates.

At 1508, the variation module 310 calculates a required pelvic angle as described above based on a required backset and current backset. At 1510, the variation module 310 calculates a head rotation angle. At 1512, the variation module 310 calculates an amount of head translation along the X-axis. At 1514, the variation module 310 exports and/or stores a head rotation angle and an amount of head translation along X-axis to a dummy positioning script.

At 1516, the variation module 310 positions the left-hand upper arm assembly 8 based on an initial position of left-hand elbow node 7 and hand positioning. At 1518, the variation module 310 positions left-hand lower arm assembly based on initial position of left-hand finger node.

At 1520, the variation module 310 links upper leg assembly, lower leg assembly, and foot assembly. At 1522, the variation module 310 sets a control point to heel node 11. At 1524, the variation module 310 translates the heel node 11 to an initial position of the heel node 11. At 1526, the variation module 310 determines a current upper leg assembly angle relative to a horizontal reference line. At 1528, the variation module 310 exports and/or saves current upper leg assembly angle to a dummy positioning script.

At 1530, the variation module 310 replicates all assembly values from left leg to right side of dummy including matching positions of right leg assembly to positions of the left leg assembly. This may also include setting a gap between the knees of the leg assemblies of the dummy. An example gap K between the knees 1600 of a dummy 1602 is shown in FIG. 16.

At 1532, the variation module 310 saves dummy positioning file(s) in memory 204 that were generated including the determined parameters of the dummy in the seat system being tested for the current variation thereof to a new and/or corresponding directory. At 1534, the variation module 310 deletes the generated variation dummy positioning model for current session (or iteration of the method of FIG. 15) from local memory of control module 202. At 1536, the variation module 310, if another model and dummy variation set of positioning parameters are to be generated, loads initial data and/or model(s) of dummy and seat system being tested and returns to operation 1501 as shown, otherwise the method ends. The loaded model(s) may include a standard dummy position model. The model(s) may include standard requirements and tolerances.

The above-described operations are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

The examples provided herein include a dummy position module performing dummy back positioning in a virtual CAE environment. This may include positioning a torso of the dummy by changing a pelvic angle. This angle may be adjusted to control the setting of a backset of the dummy. The dummy positioning module (or tool) calculates the backset as a distance between a reference node on a back of the dummy's head and a point on a skin of a head rest of a seat being tested. The tool calculates a pelvis angle required to achieve the required backset with respective to the seat.

The tool also performs dummy head leveling when the dummy head is not level. The head leveling includes changing a pelvic angle of the dummy and calculating a pelvic angle required to level the dummy head relative to a horizontal reference line and based upon reference nodes inside the dummy head. After head levelling, the delta backset is achieved with head translation.

The tool further performs positioning including hand placing the hand of the dummy beside the legs of the dummy and near a surface of the seat. The tool calculates an upper arm assembly angle β such that the upper arm assembly is in touching condition with a seatback of the seat and then calculates an angle α for the lower arm assembly to bring the hands down near a surface of the seat. The angles β and a are shown in FIG. 10. The angle β may be an angle between a vertical reference line and a centerline of the upper arm assembly. The angle α may be an angle between a horizontal reference line and a centerline of the lower arm assembly. Standard angles are used to keep the palms of the hands of the dummy facing sideways.

The tool may further perform as a dummy position variation study tool and record an initial backset and upper leg intersections (contact points) with seat parts using reference nodes. After changing the H-point of the dummy, the tool repositions the pelvis and head of the dummy according to a DOE backset requirement. The tool may also reposition the hands and legs of the dummy to maintain the standard position on the seat.

The examples disclosed herein provide a tool for automatically positioning a dummy (e.g., a BioRID dummy such as the BioRID II) on a seat system and in a virtual CAE environment based on and/or according to a consumer metric physical test setup. The examples include a tool that can determine parameter sets for simulating physical testing variations. The tool is configured to create multiple parameter sets for multiple different positions of a dummy based on DOE data. This aides in determining physical variations associated with a physical test.

The tool is configured to automatically perform the following operations, which are unique to a BioRID dummy. The operations include: back positioning with respective backset; head leveling; hand positioning; and dummy position variation generation. This tool helps to set up load cases for seat systems for different rows of a vehicle and corresponding occupants associated with various federal requirements. Physical variation from a test is able to be identified in a virtual CAE environment.

The examples disclosed herein position an occupant (or dummy) in a seat system per a consumer metric physical test with minimal inputs from a user. No specific expertise is needed to use the tool. The tool minimizes time and effort to position a dummy in a seat system according to a CAE setup. The tool is useful in each stage of a development program and minimizes manual efforts. Since the tool makes it easy to generate variation positioning parameter sets and test the generated sets, at least portions of physical testing can be eliminated and the amount of hardware used for physical testing is reduced. Testing may be performed 100% virtually. The tool enables user-to-user standardization while setting up dummy positioning.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A seat testing system comprising:
at least one of an interface and a control module configured to receive inputs;
a dummy positioning module configured i) to position an anthropomorphic test device (ATD) in a seat system to be tested in a virtual computer aided engineering environment, ii) to access target parameters including the inputs, and iii) based on the target parameters, to determine a plurality of parameters indicative of the positioning of the ATD in the seat system; and
a simulation evaluation module configured i) based on the plurality of parameters, to run the ATD and the seat system through a simulation of a collision in the virtual computer aided engineering environment, and ii) based on results of the simulation, to generate a rating of the seat system.

2. The seat testing system of claim 1, wherein the inputs include at least one of user inputs, design of experiment inputs, and consumer metrics for a physical setup.

3. The seat testing system of claim 1, wherein the ATD is a biofidelic rear impact dummy.

4. The seat testing system of claim 1, wherein the dummy positioning module is configured to automatically position the ATD in the seat system in the virtual computer aided engineering environment based on the target parameters, which include consumer metric physical test setup parameters.

5. The seat testing system of claim 1, wherein:
the dummy positioning module is configured to compare one or more of the plurality of parameters to the target parameters, and based on the comparison, adjust one or more of the plurality of parameters to generate a plurality of updated parameters including the adjusted one or more of the plurality of parameters and the other ones of the plurality of parameters; and
the simulation evaluation module is configured, based on the plurality of updated parameters, to run the ATD and the seat system through the simulation of the collision in the virtual computer aided engineering environment.

6. The seat testing system of claim 1, wherein:
the target parameters comprise a required H-point coordinates, a required backset, and an initial pelvic angle; and
the plurality of parameters comprise an updated pelvic angle, a head rotation angle, and a head translation position.

7. The seat testing system of claim 1, wherein the dummy positioning module is configured to:
position a torso of the ATD and set a backset of the ATD by changing a pelvic angle of the ATD until the backset matches a target backset; and
calculate a backset of the ATD by determining a distance between a backset node on a back of a head of the ATD and a front surface of a skin of a head rest of the seat system,
wherein the plurality of parameters include the calculated backset.

8. The seat testing system of claim 1, wherein the dummy positioning module is configured to:
determine if a head of the ATD is level based on positions of a plurality of reference nodes in the head;
in response to determining that the head is not level, change a current pelvic angle of the ATD and determine a pelvic angle at which the head is able to be leveled; and
subsequent to leveling the head, adjust a backset of the ATD to achieve a target backset by translating the head.

9. The seat testing system of claim 1, wherein the dummy positioning module is configured to:
place hands of the ATD beside legs of the ATD and near a surface of the seat system;
calculate an upper arm assembly angle of an upper arm assembly, where the upper arm assembly is in contact with a seat back of the seat system; and
calculate a lower arm assembly angle to bring the hands of the ATD down near a surface of the seat system,
wherein the plurality of parameters comprise the upper arm assembly angle and the lower arm assembly angle.

10. The seat testing system of claim 1, wherein the dummy positioning module is configured to after adjusting a H-point of the ATD to standard H-point coordinates:
position pelvis and head according to a backset requirement; and
position hands and legs of the ATD to maintain a standard position of the ATD on the seat system,
wherein the plurality of parameters comprise a resultant pelvic angle, a resultant head rotation angle and position, and locations of the hands and the legs of the ATD.

11. The seat testing system of claim 10, wherein the dummy positioning module is configured to:
recording the resultant pelvic angle, the resultant head rotation angle and position, and the locations of the hands and legs as a first positioning script; and
iteratively adjust H-point coordinates, backset, and pelvic angle of the ATD to be within tolerance ranges of the standard H-point coordinates, required backset, and a standard pelvic angle, and for each iteration generate a respective positioning script to provide a plurality of positioning scripts.

12. The seat testing system of claim 11, wherein the simulation evaluation module is configured to run a simulation for each of the first positioning script and the plurality of positioning scripts.

13. The seat testing system of claim 1, wherein the dummy positioning module is configured to:
receive required backset setting;
determine a current pelvic angle of the ATD while on the seat system;
determine a backset of a head of the ATD relative to a head rest of the seat system;
determine a rate of change in the backset per a 0.1° change in the current pelvic angle; and
determine a required pelvic angle of the ATD based on the current pelvic angle, a current backset, a require backset, and a rate of change of the backset,
wherein the plurality of parameters comprise the required pelvic angle.

14. A method for testing a seat system, the method comprising,
receiving inputs;
positioning an anthropomorphic test device (ATD) in the seat system to be tested in a virtual computer aided engineering environment;
accessing target parameters including the inputs, and, based on the target parameters, determining a plurality of parameters indicative of the positioning of the ATD in the seat system;
based on the plurality of parameters, running the ATD and the seat system through a simulation of a collision in the virtual computer aided engineering environment; and
based on results of the simulation, generating a rating of the seat system.

15. The method of claim 14, wherein:
the inputs include at least one of user inputs, design of experiment inputs, and consumer metrics for a physical setup;
the ATD is a biofidelic rear impact dummy; and
the dummy positioning module is configured to automatically position the ATD in the seat system in the virtual computer aided engineering environment based on the target parameters, which include consumer metric physical test setup parameters.

16. The method of claim 14, further comprising:
comparing one or more of the plurality of parameters to the target parameters;
based on the comparison, adjusting one or more of the plurality of parameters to generate a plurality of updated parameters including the adjust one or more of the plurality of parameters and the other ones of the plurality of parameters; and
based on the plurality of updated parameters, running the ATD and the seat system through the simulation of the collision in the virtual computer aided engineering environment.

17. The method of claim 14, further comprising:
positioning a torso of the ATD and set a backset of the ATD by changing a pelvic angle of the ATD until the backset matches a target backset; and
calculating a backset of the ATD by determining a distance between a backset node on a back of a head of the ATD and a front surface of a skin of a head rest of the seat system,
wherein the plurality of parameters include the calculated backset.

18. The method of claim 14, further comprising:
determining if a head of the ATD is level based on positions of a plurality of reference nodes in the head;
in response to determining that the head is not level, changing a current pelvic angle of the ATD and determine a pelvic angle at which the head is able to be leveled; and
subsequent to leveling the head, adjusting a backset of the ATD to achieve a target backset by translating the head.

19. The method of claim 14, further comprising:
placing hands of the ATD beside legs of the ATD and near a surface of the seat system;
calculating an upper arm assembly angle of an upper arm assembly, where the upper arm assembly is in contact with a seat back of the seat system; and
calculating a lower arm assembly angle to bring the hands of the ATD down near a surface of the seat system,
wherein the plurality of parameters comprise the upper arm assembly angle and the lower arm assembly angle.

20. The method of claim 14, further comprising after adjusting a H-point of the ATD to standard H-point coordinates:
positioning pelvis and head according to a backset requirement;
positioning hands and legs of the ATD to maintain a standard position of the ATD on the seat system,
wherein the plurality of parameters comprise a resultant pelvic angle, a resultant head rotation angle and position, and locations of the hands and legs of the ATD;
recording the resultant pelvic angle, the resultant head rotation angle and position, and the locations of the hands and legs as a first positioning script; and
iteratively adjusting H-point coordinates, backset, and pelvic angle of the ATD to be within tolerance ranges of the standard H-point coordinates, required backset, and a standard pelvic angle, and for each iteration generate a respective positioning script to provide a plurality of positioning scripts.
